(19) United States
(12) Patent Application Publication
(10) Pub. No.: US 2024/0135265 A1
(43) Pub. Date: Apr. 25, 2024

(54) METHOD, SYSTEM, AND COMPUTER-READABLE MEDIUM FOR CONNECTING USERS TO DIFFERENT TYPES OF CARE SUPPLIERS

(71) Applicant: Care Connection, LLC, Grove City, OH (US)

(72) Inventors: Susan Diane CORNISH, Grove City, OH (US); Michael Anthony ELDREDGE, Powell, OH (US)

(21) Appl. No.: 18/153,243

(22) Filed: Jan. 11, 2023

Related U.S. Application Data
(60) Provisional application No. 63/418,153, filed on Oct. 21, 2022.

(51) Int. Cl. G06Q 10/02; G06Q 30/0283

(52) U.S. Cl. CPC G06Q 10/02; G06Q 30/0283

(57) ABSTRACT

Computer-implemented methods and systems for connecting users including sponsored users to different types of care suppliers through a platform coupled over a network to one or more remote devices accessed by users are described. A method includes enabling a sponsored user to book a type of care using a mobile application on a remote computing device communicatively coupled to the platform. The method further includes receiving a request from the sponsored user identifying a desired care type; determining, by a platform, a set of candidate care providers that satisfy matching criteria for the received user request; enabling the sponsored user to select through the mobile application a care provider from the determined set of candidate care providers; and enabling the sponsored user to remit payment to the care provider upon completion of an associated care transaction.

### CROSS-REFERENCE TO RELATED APPLICATION(S)

This application claims the benefit of priority to U.S. provisional patent application no. 63/418,153, filed on Oct. 21, 2022, and which is incorporated by reference in its entirety herein.

### FIELD OF THE DISCLOSURE

The technical field relates generally to mobile applications and a cloud-computing platform, and more particularly, to mobile applications for obtaining the services of a care supplier through a cloud-computing platform.

### BACKGROUND OF THE DISCLOSURE

When scheduling a care supplier, such as a babysitter or an elderly in-home care provider, the process may necessitate vetting candidates, comparing costs, identifying availabilities for scheduling, and handling payments. With the complexity and number of moving parts involved, this process may become costly and an undue burden for both the care supplier and the care seeker. In the case of emergencies, or situations in which the scheduling must occur in a short time-frame, the quality of care received may be poor, the urgency may be cost-prohibitive, and services may be unavailable. Users may be unable to connect with available care suppliers resulting in care giving needs being unmet and care suppliers being underutilized. Further, without an existing client base for care suppliers, or a regular supplier for care seekers, a high barrier to entry may exist for those looking to provide or acquire care.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment, a computer-implemented method for connecting users including sponsored users to different types of care suppliers through a platform coupled over a network to one or more remote devices accessed by users is provided. The method includes initializing sponsor, supplier, and user accounts to obtain account data and storing the initialized account data in a database coupled to the platform, and enabling a sponsored user to book a type of care using a mobile application on a remote computing device communicatively coupled to the platform. The method further includes receiving a request from the sponsored user identifying a desired care type; determining, by the platform, a set of candidate care providers that satisfy matching criteria for the received user request; enabling the sponsored user to select through the mobile application a care provider from the determined set of candidate care providers; and enabling the sponsored user to remit payment to the care provider upon completion of an associated care transaction.

In a further embodiment, a computer-implemented system for connecting users including sponsored users to different types of care suppliers is provided. The system includes a care connection platform and a database. The platform is configured to couple over a network to one or more remote devices having a mobile application accessed by a sponsored user. The care connection platform is configured to: enable a sponsored user to book a type of care using a mobile application on a remote computing device communicatively coupled to the platform; receive a request from the sponsored user identifying a desired care type; and determine a set of candidate care providers that satisfy matching criteria for the received user request.

The platform is further configured to enable the sponsored user to select through the mobile application a care provider from the determined set of candidate care providers; and enable the sponsored user to remit payment to the care provider upon completion of an associated care transaction.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a system which connects users and care suppliers using a cloud-based care connection service platform according to an embodiment of the present invention.

FIG. 2 shows an example cloud-based service platform of FIG. 1 in further detail.

FIGS. 3A and 3B are example diagrams that illustrate computer-implemented transaction processes and capabilities in accordance with embodiments of the present invention.

FIG. 4 is an example computer-implemented method for connecting users to different types of care suppliers according to an embodiment of the present invention.

FIG. 5 is a flowchart for an example transaction including payment.

FIG. 6 is an example splash screen for a mobile application according to an embodiment of the present invention.

FIG. 7 is an example landing page for a mobile application.

FIG. 8 is an example display view for selecting a user type within a mobile application.

FIG. 9 is an example booking display view incorporating several examples of supplied care within a mobile application.

FIG. 10 is an example calendar display view for the booking of services in a date range within a mobile application.

FIG. 11 is an example display view for selecting a specific care provider within a mobile application.

FIG. 12 is an example display view for the comparison of specific care providers based upon multiple criteria.

FIG. 13 is an example display view for selecting preferences within a mobile application.

FIG. 14 is an example display view for providing payment information within a mobile application.

FIG. 15 is an example display view for selecting a start time for a care request.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to mobile applications and, more particularly, to mobile applications for obtaining the services of a care supplier.

Care Connection System

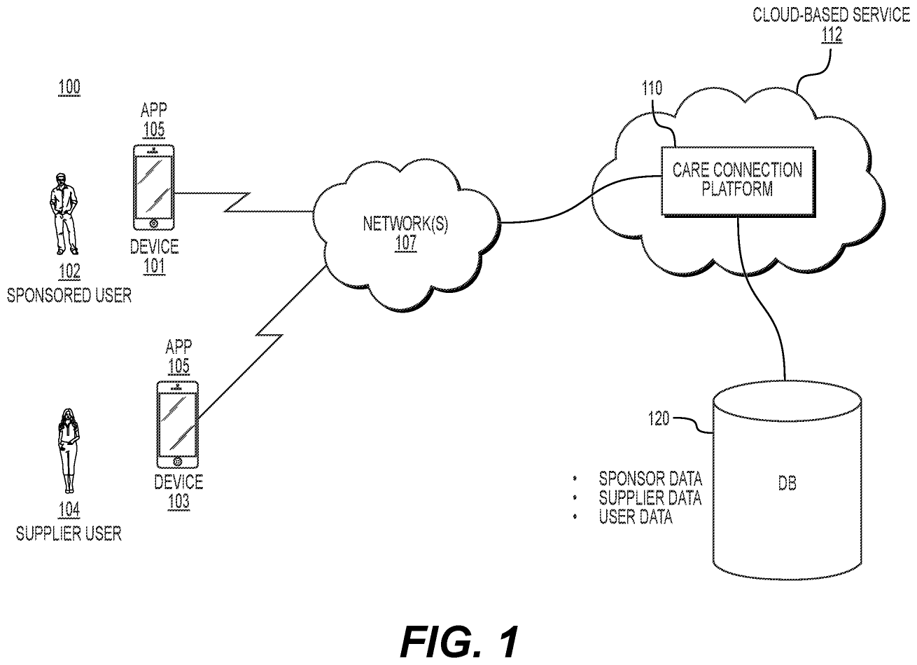

FIG. 1 is an example of a system 100 which connects users and care suppliers to a cloud-based service 112. Using a first device 101, a sponsored user 102 may seek care services related to childcare, pet care, house care, elderly care, or any combination thereof. It should be noted that the type of care service sought may differ from the list provided herein without departing from the scope of the present disclosure. Using a second device 103, a supplier user 104 may have availability for the provision of care. Using a mobile application 105, both the sponsored user 102 and the supplier user 104 may facilitate the receipt or provision of care over one or more networks 107. Through the mobile application 105 and the one or more networks 107, both the sponsored user 102 and the supplier user 104 may connect to care connection platform 110 as part of a cloud-based service 112. For example, devices 101, 103 can be client devices coupled to communicate with one or more servers in care connection platform 110. The care connection platform 110 may be communicatively coupled to a database 120 which stores sponsor data, supplier data, user data, and any other data which may be necessary for the facilitation of services. In at least one embodiment, the supplier user 104 may be a supplier employer user which may facilitate the addition of further supplier users 104, as well as modify the availability of other supplier users 104.

In embodiments, a device 101, 103 can be any electronic computing device. A user can enter control inputs through a user interface (such as a keyboard, microphone, or touchscreen). For example, device 101, 103 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 107.

Mobile application 105 can be an application implemented to run on a device 101, 103 and downloadable from an application store. Mobile application 105 can also be implemented as a web application which operates through a browser on device 101, 103.

Care Connection Platform

In one example, platform 110 is implemented on one or more servers as a software-as-as-service (SaaS). The servers include one or more processors and can be distributed at the same or different locations. Network(s) 107 may be one or more data networks or combination of networks including, but not limited to, a local area network, medium area network or wide area network, such as, the Internet. Web servers may also be included and coupled to servers of platform 110 to support SaaS operations on platform 110 and enable communications (through Web protocols and networking layers) between platform 110 and browsers on remote computing devices 101, 103.

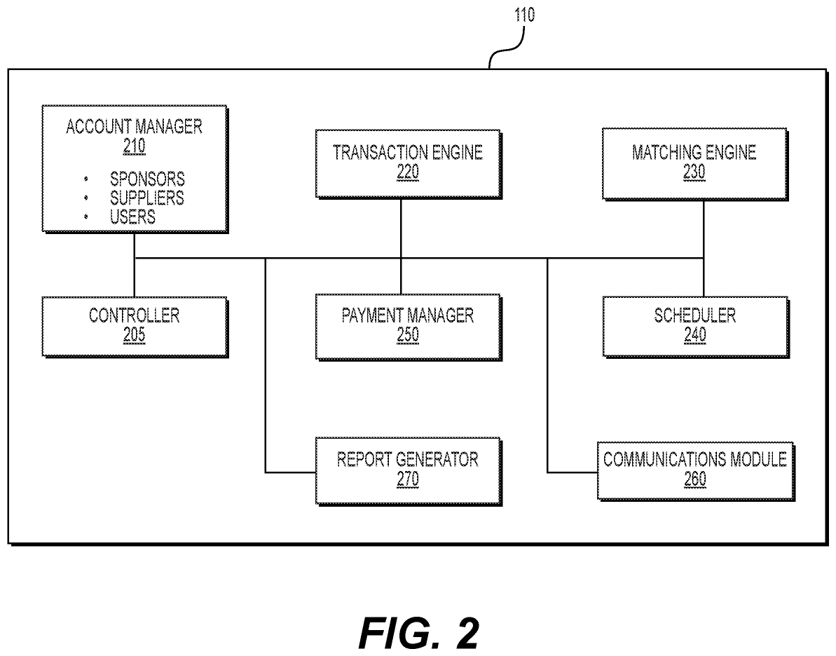

FIG. 2 is an example of a cloud-based care connection service platform 110 with example components. A controller 205 within the platform 110 may facilitate the operations undertaken within the platform 110 which allow for the full care supply and demand process to take place. As part of the platform 110, an account manager 210 may be utilized for the handling of user data which may be found on a database (e.g., database 120). The account manager 210 may be capable of managing accounts for sponsors who allow access to the platform 110, suppliers who provide services, and users who are seeking services. As a part of the operations of the platform 110, transactions may be completed using a transaction engine 220. As part of the transaction, the matching of care suppliers and care seekers may be performed within a matching engine 230 which may account for location, availability, type of care, and additional filters. After matching is performed, a scheduler 240 may verify the requested date, the availability of the provider, and subsequently update the schedule of the provider. The platform 110 and the scheduler 240 may have the capability to communicate with external scheduling systems to facilitate this process without departing from the scope of the present disclosure.

During the transaction, the platform 110 may facilitate any payments made from the care seeker to the service provider, the platform owner, or any other payment recipient, via the payment manager 250. Additionally, during and after the transaction, an internal function may allow for the communication between the care provider and the care seeker within the platform 110 via the communications module 260. The communications module 260 may allow the care seeker and the care provider to voice chat or pass messages, pictures, and videos regarding the care being provided. As a final step in the transaction, the platform 110 may facilitate the generation of a report via the report generator 270. The report produced by the report generator 270 may provide a summary of care provided, a receipt of the payment undertaken, a review of the care provided, and any other information relevant to the transaction.

Care Connection Processes

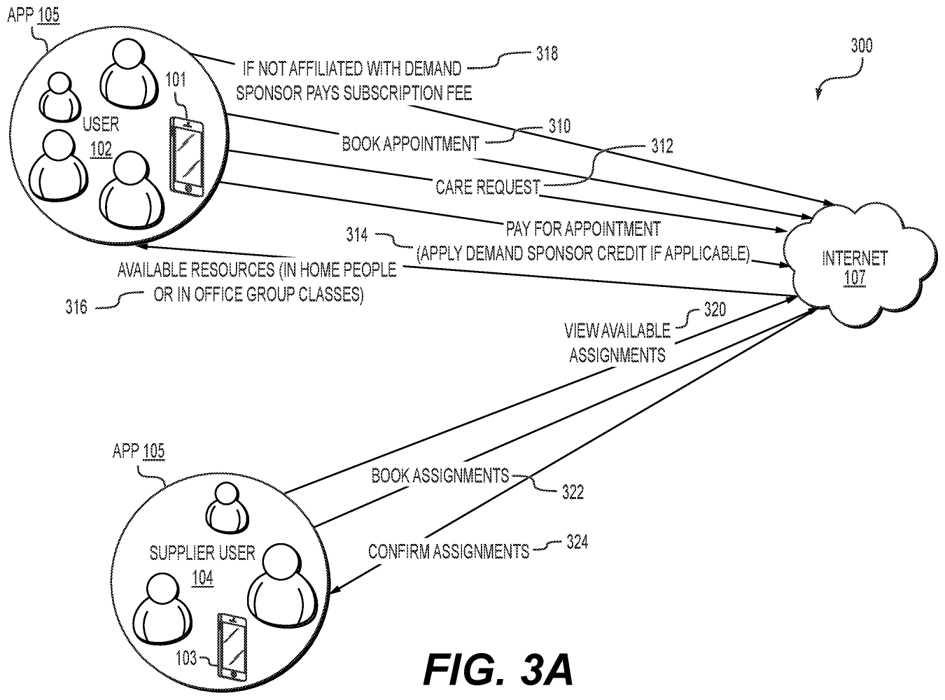

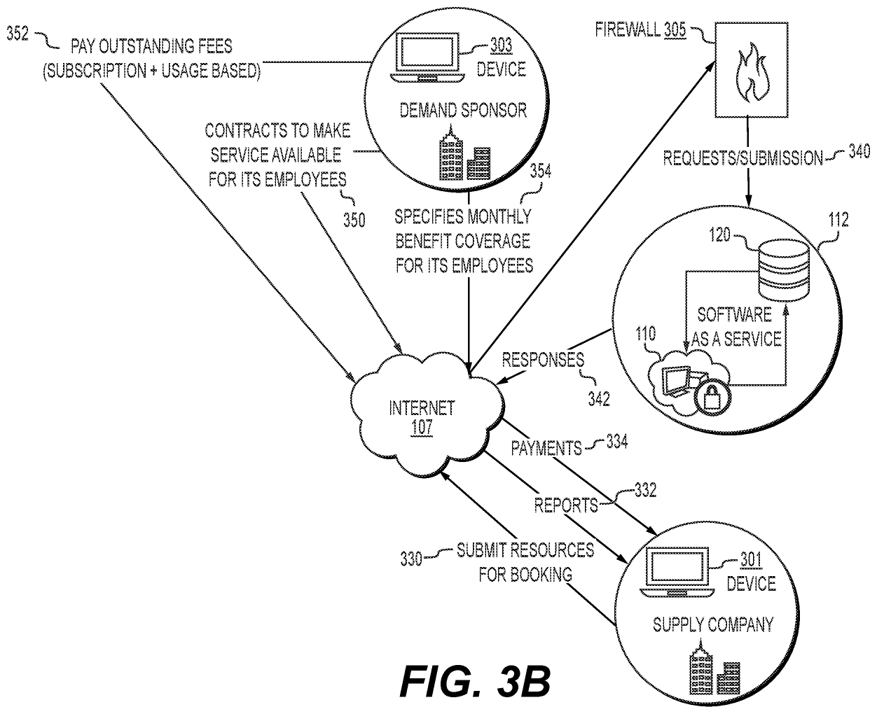

FIGS. 3A and 3B are example diagrams of the transaction process and capabilities in accordance with several embodiments of the present disclosure. The transaction process 300 (hereafter “the process 300”) may share similar elements to the system 100 and the method 200, and therefore may be best understood with reference thereto, where like numerals will represent like components not described again. In FIG. 3A, the user 102 and supplier user 104 portions of the process 300 are illustrated as the first device 101 and the second device 103 interface with the internet 107. FIG. 3B illustrates example demand sponsor, supply company, and cloud-based service 112 portions of process 300. As such, process 300 described herein will actively reference both FIGS. 3A and 3B.

As before, through a first device 101, a user 102 may access an application 105 while at any portion of the transaction in the process 300. Simultaneously, through a second device 103, a supplier user 104 may access the application 105 while at any portion of the transaction in the process 300. The application 105 may connect to the internet 107 to facilitate the process 300, which may include a connection to a third device 301 at a supply company, a connection to a fourth device 303 at a demand sponsor, and a connection to the cloud-based service 112, which may include the platform 110 and the database 120, through a firewall 305.

When accessing the application 105, the user 102 may initiate a number of functions over the internet 107. The user 102 has the ability to book appointments 310, create a care request 312, pay for an appointment 314, and provide information regarding available resources 316. It should be noted that while the user 102 may pay for an appointment 314, the demand sponsor may provide credit as a portion of or all of the transaction as part of the sponsorship. If the user 102 is not a member of a demand sponsor company, however, the user 102 may need to pay subscription fees 318 which may normally be covered by the demand sponsor. Similarly, when accessing the application 105, the supplier user 104 may view available assignments 320, book assignments 322, and confirm assignments 324 as part of the process 300. In at least one embodiment, the supplier user 104 may be a supplier employer user which may facilitate the addition of further supplier users 104, as well as modify the availability of other supplier users 104.

While the supplier user 104 may access the application 105 for the previously described portions of the process 300, the supply company (or supplier employer user) may, through the third device 301, perform additional functionality over the internet 107 as shown in FIG. 3B. The supply company may submit resources for booking 330, view and/or generate reports 332, and process payments 334. Similarly, through a fourth device 303, the demand sponsor may perform a number of transactions in the process 300. The demand sponsor may contract 350 with the service in order to make the service available to its employees, pay outstanding fees 352 such as subscription fees and usage-based costs, and specify the monthly benefit coverage for its employees 354.

All requests from the user 102, the supplier user 104, the demand sponsor, and the supply company may be routed through the internet 107 to the firewall 305. The firewall 305 may process any incoming data, requests, and submissions provided by each user or company type before providing the data to the cloud-based service 112. After assessing the incoming data, the firewall 305 may pass on the legitimate and non-threatening requests or submissions 340 to the cloud-based service 112 such that the platform 110 may handle the presented transactions as part of the process 300. Finally, once the requests or submissions 340 have been handled by the cloud-based service 112, the responses from the platform 110 may be returned to the necessary parties over the internet 107.

Connection to Different Types of Care Suppliers

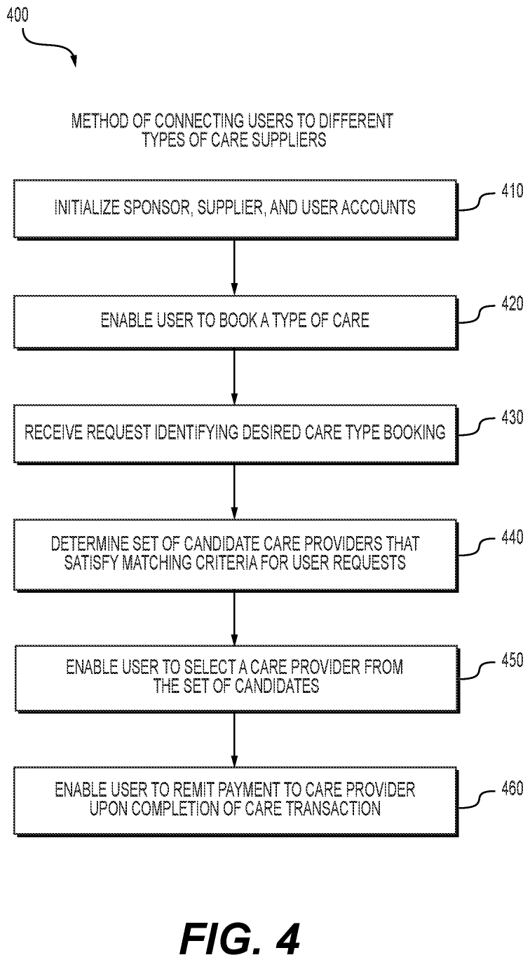

FIG. 4 is an example method 400 for connecting users to different types of care suppliers (steps 410-460). At step 410, the platform (e.g., the platform 110) may initialize the accounts of the sponsor who may allow access to the method, the supplier who may provide care, and the user who may be seeking care. At 420, the platform may enable the user to book one or more desired types of care. The care provided within the method 400 may include, but is not limited to, childcare, elderly care, pet care, and house care. At step 430, the platform may receive a request identifying the desired type of care booking enabled at step 420. At step 440, the platform may determine a set of candidate care providers that match criteria which satisfy the user request. The platform may then enable a user at to select a care provider step 450 from the set of candidates determined at step 440. Following the provision of care, the method 400 and the platform may allow the user to remit payment to the care provider at step 460, thus completing the care transaction.

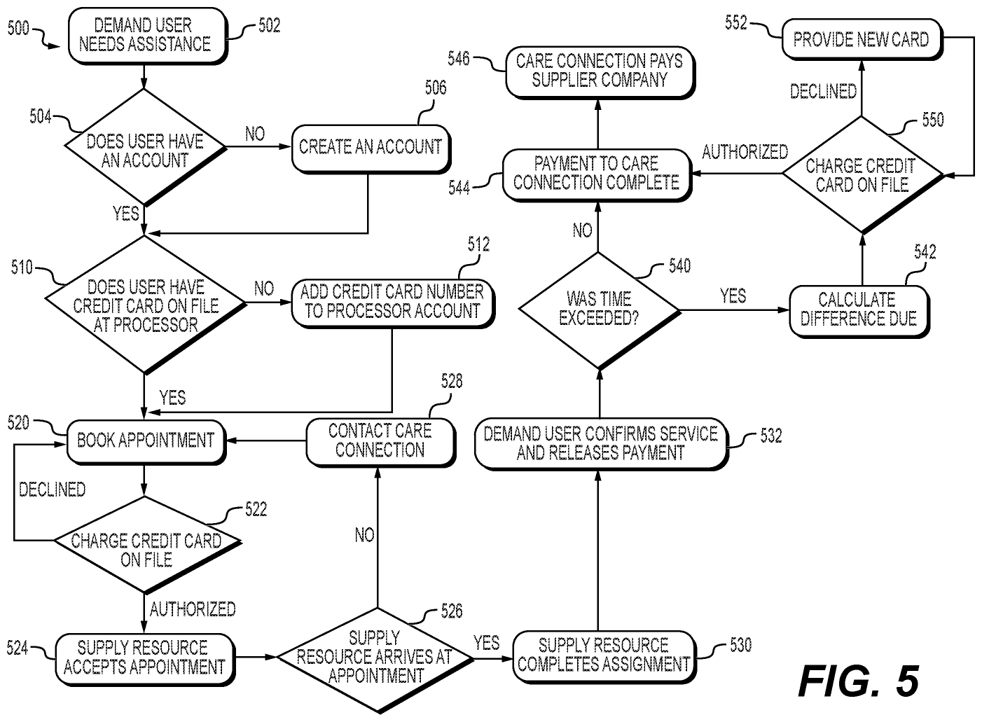

FIG. 5 is a flowchart for an example transaction method 500 including payment (steps 502-552). In an embodiment, a transaction according to method 500 may be implemented on platform 110 as described herein. Method 500 begins with a demand user needing assistance at step 502. As such, method 500 and user (e.g., sponsored user 102) may determine if the user has an account at step 504. Should the user be new to the system and be without an account, the user may create an account at step 506. Once an account is created at step 506, or determined to exist already at step 504, method 500 may advance and determine if the user has a credit card on file at the processor at step 510. Similar to the user account steps previously taken, if the user does not have a credit card on file at step 510, the user may add a credit card at step 512. Once a credit card is supplied or verified, method 500 may advance to booking the appointment at step 520.

After step 520, and during the appointment booking process, method 500 may require the initial charge of a credit card on file at step 522. If the card is declined within step 522, method 500 returns to step 520 to rebook an appointment. If the card is authorized in step 522, the supply resource may accept the appointment at step 524. After acceptance at step 524, it may be determined if the supply resource (e.g., the supplier user 104) arrived at the required appointment at step 526. If the supply resource fails to arrive at the appointment at step 526, the method enables the contact of the company (e.g., a company operating platform 110 and carrying out method 500) at step 528 such that remedial actions may be taken. These actions taken at step 528 may include, but are not limited to, a refund of the charge performed at 522, a reduction in rating for the supply resource, a discount to the user for future services, or immediate rescheduling of service with a new supply resource. Regardless of the outcome at step 528, method 500 may enable a return to the booking of a new appointment.

If the supply resource correctly arrives at the appointment in step 526, the supply resource may then complete the assignment at step 530. After completion of service at step 530, the demand user may then confirm the rendered service and release a payment to the company at step 532. Should a predetermined time for the task have been previously decided at step 520, the comparison between the predetermined time and the actual time taken may occur at step 540. If the actual time exceeded the predetermined time, the time difference and hourly rate of the supply resource are used at step 542 to determine the difference due to the supply resource and company. This difference calculated at step 542 may then be charged to the user's card on file at step 550. If at this point in the process the user's card is declined, the user will be prompted to provide a new card at step 552. While not shown here, if the user fails to provide a new card at step 552, remedial actions may be taken up to an including, but not limited to, sending the client account to a collections company. Once either the correct payment is received in step 550, or the time was determined to not have been exceeded in step 540, the payment to the company may be completed in step 544. Once the company is in possession of the total charge at step 544, the company may then pay the supplier company at step 546 which may then handle the payment of the supply resource within their organization.

### User-Interface Examples

Platform 110 and its operation will now be described with respect to user-interface (UI) examples according to an embodiment. These UI examples are illustrative and not intended to be limiting. A person skilled in the art given this description with understand that alternative UI configurations with different display views and controls may be used in accordance with embodiments of the present invention.

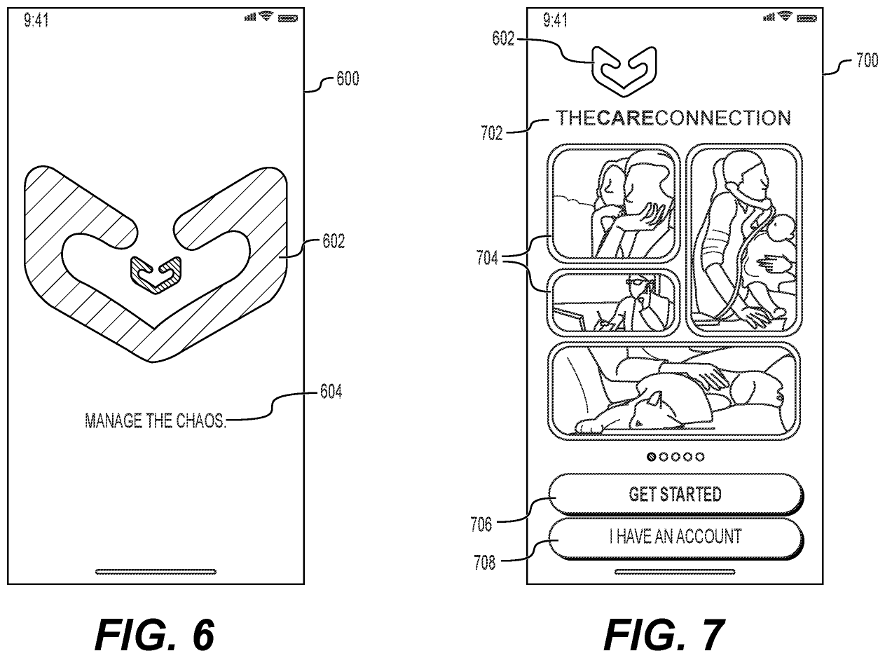

FIGS. 6-15 are example screenshots in accordance with several embodiments of the present disclosure which may be accessible through an application (e.g., the application 105) on a user's mobile device (e.g., the devices 101 and 103). The example screens may display various capabilities of the application, which may use a mouse and keyboard input, a touch screen input, or any other input device to operate selectable portions of the application and enter the required information. The example screenshots in FIGS. 6-15 may depict successive screens which may interconnect, however those skilled in the art will readily appreciate that the functionality and order of screens may vary from the embodiments below without departing from the scope of this disclosure.

FIG. 6 is an example splash screen 600 for a mobile application. The splash screen may contain a logo 602 and a slogan 604, as well as any additional identifying information to be provided to a user while initializing the application on their device.

FIG. 7 is an example landing page 700 for a mobile application. The landing page 700 may contain the logo 602, the application name 702, promotional images 704, a new user button 706, and an existing user button 708. The new user button 706 and the existing user button 708 may advance the user to the next stage of using the application, and may lead to different pages based upon the user type.

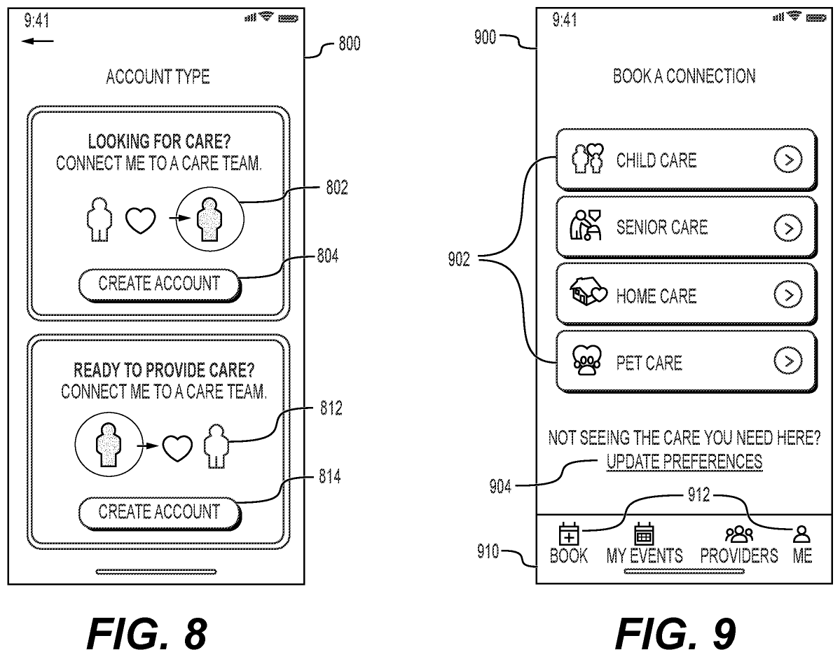

FIG. 8 is an example screen for selecting a user type 800 within a mobile application. In a previous screen, on the landing page 700, the selection of the new user button 706 may lead the user to the screen for selecting a user type 800. This screen may have a first user image 802 with a corresponding first account creation button 804, and a second user image 812 with a corresponding second account creation button 814. The first user image 802 may depict a user obtaining care with accompanying text, while the second user image 812 may depict a user providing care with accompanying text. By selecting the first account creation button 804, the user may begin account creation for a user looking for care. Similarly, by selecting the second account creation button 814, the user may begin account creation for a user looking to provide care.

FIG. 9 is an example booking screen incorporating several examples of supplied care 900 within a mobile application. In the example booking screen incorporating several examples of supplied care 900, there may be a collection of buttons 902 corresponding to desired care types. These care types may include child care, senior care, home care, and pet care. It should be noted, however, that additional care types may be included herein without departing from the scope of the present disclosure. Additionally, a preferences button or selectable text 904 may be presented on the screen for customization of the buttons shown in the collection of buttons 902 for the desired services rendered. Additionally, a lower bar 910 may be present within the screen which contains lower buttons 912 which correspond to different pages of the application. The lower buttons 912 may include, but are not limited to, a booking button, a calendar button, a provider list button, and a user profile button.

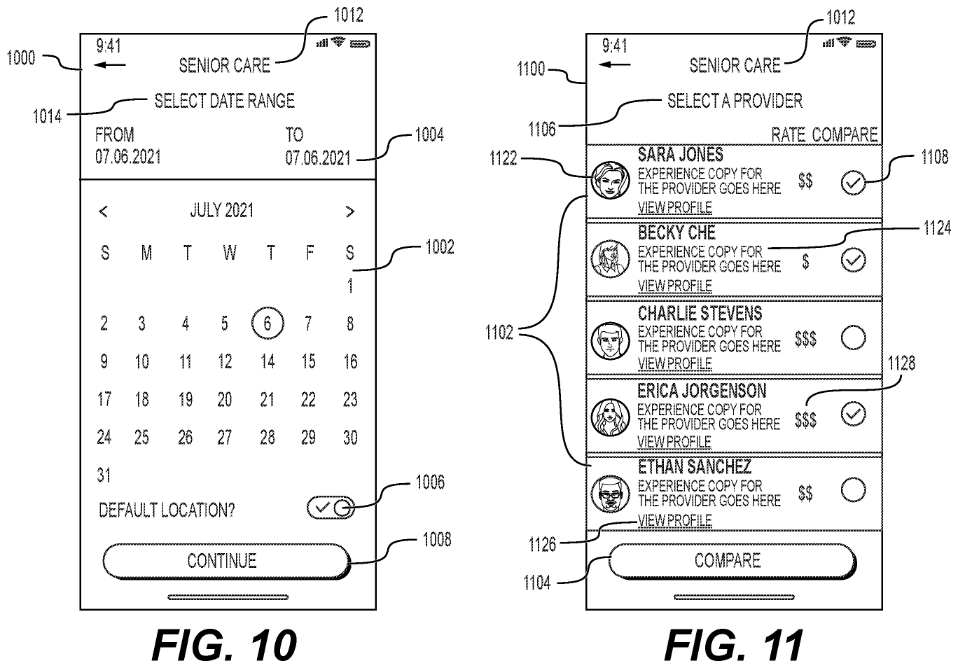

FIG. 10 is an example calendar screen 1000 for the booking of services in a date range within a mobile application. The calendar screen 1000 may include an interactive calendar 1002, a date range 1004, a location toggle 1006, and a continue button 1008. The calendar screen 1000 may additionally contain text specifying the care type selected 1012 and instruction text 1014 which provides instructions for the specific screen. The interactive calendar 1002 may allow users to specify a timeframe in which the care is needed with a start and end date, which may also be shown in the date range 1004. The location toggle 1006 allows the user to specify if the location of the care corresponds to the default location which may be defined by the user. While not shown here, if the location toggle 1006 is changed to the off position, the calendar screen 1000 may additionally provide an input area for the desired location, or may alter an internal flagger to request the desired location on a further screen. Once the date has been selected on the interactive calendar 1002, the user may use the continue button 1008 to move to the next screen in the booking process.

FIG. 11 is an example screen for selecting a specific care provider 1100 within a mobile application. The screen for selecting a specific care provider 1100 may contain a list or grid view of provider profiles 1102, a lower button 1104, text specifying the care type selected 1012, instruction text 1106 which provides instructions for the current screen, and selection indicators 1108 corresponding to each provider profile. The lower button 1104 may allow the user to continue the process when only one selection indicator 1108 is selected, denoting that the corresponding care provider has been chosen. Alternatively, if multiple care providers are selected in the selection indicators 1108, the lower button 1104 may allow for the user to proceed to a screen which compares the selected care providers. The screen for selecting a care provider 1100 may additionally include further information within the provider profiles 1102. The further information may include a representative image 1122 for the provider, informational text 1124 provided by the provider, a view profile button 1126 which leads to a full profile of the provider, and a cost representation 1128 to show the usual price range for using the provider's services.

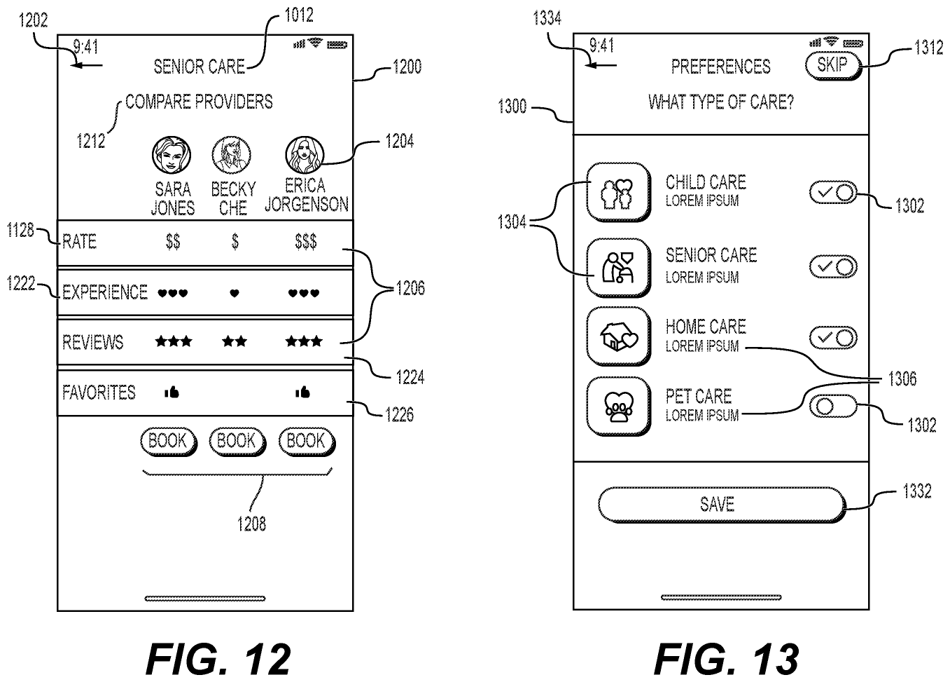

FIG. 12 is an example screen for the comparison of specific care providers 1200 based upon multiple criteria. The screen for the comparison of specific care providers 1200 may include a back button 1202, images/names of care providers 1204, compared qualities 1206, booking buttons 1208, text specifying the care type selected 1012, and instruction text 1212 which provides instructions for the current screen. The user may use the back button 1202 to return to a previous screen (e.g., the screen for selecting a specific care provider 1100), while the booking buttons 1208 may allow the user to proceed with the booking process. The compared qualities 1206 may include, but are not limited to, the cost representation 1128, the experience level 1222, the review rating 1224, and the favoriting status 1226.

FIG. 13 is an example screen for selecting preferences 1300 within a mobile application. The screen for selecting preferences 1300 may include a collection of toggles 1302 corresponding to desired care types, which may be accompanied by representative images 1304, and informational text 1306. The screen for selecting preferences 1300 may follow from the selection of the selectable text 904 from the screen incorporating several examples of supplied care 900. Alternatively, the screen for selecting preferences 1300 may be a default screen when first creating an account, in which case a skip button 1312 may allow a user to advance the process without changing selections made to the toggles 1302. If the user is altering their selections previously made, the user may save their new preferences using the save button 1332, or may exit the screen using the back button 1334.

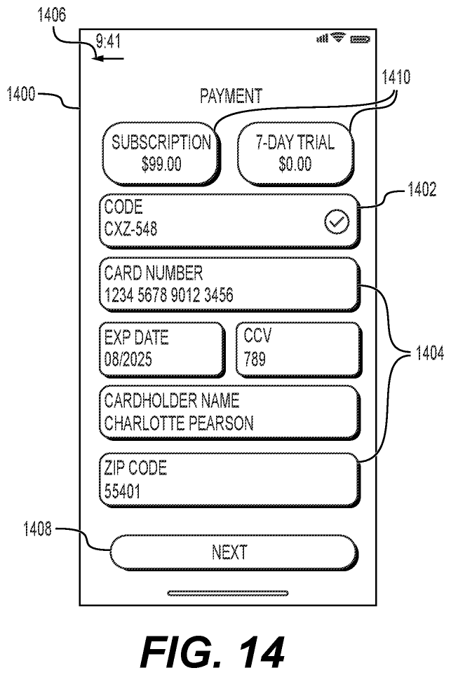

FIG. 14 is an example screen for providing payment information 1400 within a mobile application. The screen for providing payment information 1400 may include a code box 1402, payment information boxes 1404, a back button 1406, a next button 1408, and one or more selectable payment options 1410. The code box 1402 may allow the input of a code which provides a discount, a trial, a promotion, or any other benefit which may be provided in a code format. The payment information boxes 1404 allow a user to input card payment information into the system for use in the transaction. The back button 1406 may allow the user to back out of the transaction, while the next button 1408 may lead to screens including, but not limited to, a screen requesting additional information or a confirmation page before processing the transaction. The one or more selectable payment options 1410 may include the type of service payment and the cost.

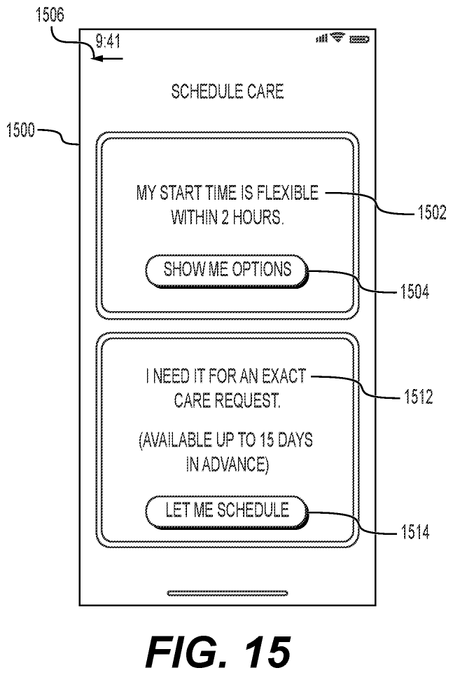

FIG. 15 is an example screen for the selection of a flexible or exact start time 1500 for a care request. In embodiments, the screen for the selection of a flexible or exact start time 1500 is displayed after the screen for the comparison of specific care providers 1200 or after the screen for providing payment information 1400 in order to finalize the details of the appointment. The screen for the selection of a flexible or exact start time 1500 may include a first set of informational text 1502 which may describe a flexible start time with a corresponding first scheduling button 1504, and a second set of informational text 1512 describing an exact start time with a corresponding second scheduling button 1514. The first scheduling button 1504 may lead to a selection of a preferred window of time for the flexible start time, while the second scheduling button 1514 may lead to a specific scheduling time for provision of care. The screen for the selection of a flexible or exact start time 1500 may additionally include a back button 1506 to allow a return to the previous screen. In at least one embodiment, the screen for the selection of a flexible or exact start time 1500 may follow the example calendar screen 1000.

### Further Embodiments and Example Implementations

Aspects of the embodiments for exemplary system 100 including platform 110 (and components 205 and 210-270) and database 120 thereof may be implemented electronically using hardware, software modules, firmware, tangible computer readable or computer usable storage media having instructions stored thereon, or a combination thereof and may be implemented in one or more computer systems or other processing systems. In embodiments, platform 110 including each of components 205 and 210-270 may be implemented electronically using hardware, software modules, firmware, tangible computer readable or computer usable storage media having instructions stored thereon, or a combination thereof and may be implemented in one or more computer systems or other processing systems at the same location or different locations.

Example computing devices (such as remote computing devices 101, 103) that may be used by users (such as remote users 102, 104) include, but are not limited to, a mobile computing device (such as a smartphone or tablet computer), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device.

Embodiments may be directed to computer products comprising software stored on any computer usable medium such as memory. Such software, when executed in one or more data processing device, causes a data processing device(s) to operate as described herein.

In an embodiment, platform 110, including components 205 and 210-270, and database 120 may be implemented in an architecture distributed over one or more networks 107, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), application programming interface as a service (APIaaS), or an integration platform as a service (IPaaS).

Storage database 120 for example may be a database platform running database management software available from an organization such as a commercial vendor or open source community.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable, or machine-readable, instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A non-transitory computer-readable medium for connecting users to different types of care services, the computer-readable medium storing machine-readable instructions, which, when executed by a processor of an electronic device, cause the electronic device to:
initialize a user account of a demand user within a care platform;
enable the demand user to book one or more care services from among multiple different types of care services through the care platform;
receive a request identifying the one or more care services desired;
determine a set of candidate care providers;
enable the demand user to select a care provider from the set of candidate care providers; and
enable the demand user to remit payment to the care provider.

2. The non-transitory computer-readable medium of claim 1, wherein the machine-readable instructions further cause the electronic device to:
enable the demand user to provide one or more criteria for the set of candidate care providers; and
determine the set of candidate care providers utilizing the one or more criteria provided by the demand user.

3. The non-transitory computer-readable medium of claim 1, wherein the machine-readable instructions further cause the electronic device to initialize a user account of a supplier user, a sponsor user, or any combination thereof.

4. The non-transitory computer-readable medium of claim 3, wherein the sponsor user may enable the demand user to connect to the care platform.

5. The non-transitory computer-readable medium of claim 1, wherein the machine-readable instructions further cause the electronic device to:
enable the demand user to verify a successful completion of a care service; and
generate a report comprising a payment receipt, a description of services provided, and information of users involved in a transaction.

6. The non-transitory computer-readable medium of claim 5, wherein the machine-readable instructions further cause the electronic device to:
compare time taken to provide service with an estimated provided before service;
calculate a difference between payment provided and payment required based upon the time taken to provide service; and
charge the demand user for the difference.

7. The non-transitory computer-readable medium of claim 5, wherein the machine-readable instructions further cause the electronic device to:
enable the demand user to provide a rating for the care service provided by a care provider;
compile review information for each care provider on the care platform; and
display, on one or more second electronic devices, the review information compiled.

8. The non-transitory computer-readable medium of claim 1, wherein the machine-readable instructions further cause the electronic device to:
enable creation of a new user account for demand users, sponsor users, supplier users, or any combination thereof, who lack an existing user account; and
collect payment information from an owner of the new user account for giving or receiving payments through the care platform.

9. The non-transitory computer-readable medium of claim 1, wherein the one or more care services include childcare, elderly care, pet care, home care, or any combination thereof, and wherein the machine-readable instructions further cause the electronic device to enable the demand user to select a flexible start time or an exact start time for a request to schedule care from a selected provider of the one or more care services.

10. A system for connecting users to different types of care services, comprising:
a first device used by a demand user with a need for a care service provider, the first device comprising a network interface;
a second device used by a supplier user with availability for provision of one or more care services, the second device comprising a network interface;
a cloud-based service comprising a platform which facilitates one or more aspects of the provision of the one or more care services; and
a database comprising an element selected from the group including demand user data, supplier user data, or any combination thereof.

11. The system of claim 10, the platform comprising:
a controller which facilitates actions of the platform;
an account manager which manages data found within the database;
a transaction engine;
a matching engine which pairs the demand user with the supplier user based upon preferences provided by the demand user;
a scheduler;
a payment manager;
a communications module; and
a report generator.

12. The system of claim 11, wherein the preferences provided by the demand user comprises an element selected from the group including location, availability, type of care needed, or any combination thereof.

13. The system of claim 11, wherein the scheduler communicates with external scheduling systems and connects with an existing schedule to determine availability of the supplier user.

14. The system of claim 11, wherein the communications module enables an element selected from the group consisting of voice calls, video calls, the messaging of text, pictures, and videos, and any combination thereof.

15. The system of claim 10, further comprising a third device used by a sponsor which allows access to the platform for demand users.

16. The system of claim 10, wherein the one or more care services include childcare, elderly care, pet care, home care, or any combination thereof.

17. A computer-implemented method for connecting users to different types of care suppliers over a remote cloud-based service having a computer-implemented care platform, the method having steps implemented electronically on the computer-implemented care platform comprising:
determining if a demand user has an account on a care platform and a credit card on file with the care platform;
booking an appointment for care services through the care platform;
charging the credit card of the demand user on file;
determining if a supply resource arrived at the appointment;
confirming execution of care services according to information provided when booking the appointment; and
facilitating payment between the demand user and the supply resource or a company employing the supply resource.

18. The method of claim 17, further comprising:
creating an account for the demand user if the account does not exist; and
requesting credit card information from the demand user if the credit card if not on file with the care platform.

19. The method of claim 17, further comprising:
determining if time taken for the appointment exceeds a time estimate provided while booking the appointment;
calculating a difference in price for the appointment based upon a difference in time and an hourly rate for the supply resource; and
charging the difference in price to the credit card on file for the demand user.

20. The method of claim 17, wherein the demand user is provided the account by a sponsor which enables access to the care platform via a subscription model.

21. A computer-implemented method for connecting users including sponsored users to different types of care suppliers through a platform coupled over a network to one or more remote devices accessed by users, comprising:
initializing sponsor, supplier, and user accounts to obtain account data and storing the initialized account data in a database coupled to the platform;
enabling a sponsored user to book a type of care using a mobile application on a remote computing device communicatively coupled to the platform;
receiving a request from the sponsored user identifying a desired care type;
determining, by the platform, a set of candidate care providers that satisfy matching criteria for the received user request;
enabling the sponsored user to select through the mobile application a care provider from the determined set of candidate care providers; and
enabling the sponsored user to remit payment to the care provider upon completion of an associated care transaction.

22. A computer-implemented system for connecting users including sponsored users to different types of care suppliers, comprising:
a care connection platform configured to couple over a network to one or more remote devices having a mobile application accessed by a sponsored user; and
a database coupled to the care connection platform; wherein the care connection platform is configured to:
enable a sponsored user to book a type of care using a mobile application on a remote computing device communicatively coupled to the platform;
receive a request from the sponsored user identifying a desired care type;
determine a set of candidate care providers that satisfy matching criteria for the received user request;
enable the sponsored user to select through the mobile application a care provider from the determined set of candidate care providers; and
enable the sponsored user to remit payment to the care provider upon completion of an associated care transaction.

23. The computer-implemented system of claim 22, wherein the care connection platform is further configured to:
receive account data including data representative of sponsor, supplier, and user accounts; and
output the account data for storage in the database.
